(19) United States
(12) Patent Application Publication
(10) Pub. No.: US 2014/0204349 A1
(43) Pub. Date: Jul. 24, 2014

(54) ILLUMINATION SYSTEM AND PROJECTION DEVICE COMPRISING THE SAME

(71) Applicant: DELTA ELECTRONICS, INC., Taoyuan Hsien (TW)

(72) Inventors: Yu-Hsi WU, Zhongli City (TW); Chi-Hsuan HSU, Yangmei City (TW)

(73) Assignee: DELTA ELECTRONICS, INC., Taoyuan Hsien (TW)

(21) Appl. No.: 13/744,516

(22) Filed: Jan. 18, 2013

(51) Int. Cl. G03B 21/28; F21V 13/08; F21V 17/02; G03B 21/16

(52) U.S. Cl. CPC G03B 21/28; G03B 21/16; F21V 13/08; F21V 17/02
USPC 353/84; 362/269; 362/235

(57) ABSTRACT

An illumination system and a projection device comprising the same are provided. The projection device comprises an imaging system and the illumination system. The illumination system comprises a first light source, a color wheel and a reflecting mirror. The first light source provides a first wave band light along a first axial direction. The color wheel rotates around a second axial direction. The first axial direction is perpendicular to the second axial direction. A first wave band transforming area is formed around an edge of the color wheel, and the reflecting mirror is disposed adjacent to the edge of the color wheel. When being projected to the first wave band transforming area, the first wave band light is transformed into a second wave band light by the first wave band transforming area and then the second wave band light is reflected by the reflecting mirror.

This application claims the benefit of the priority to Taiwan Patent Application No. 101105713 filed on Feb. 22, 2012, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to an illumination system and a projection device comprising the same. More particularly, the present invention relates to an illumination system that carries out wavelength transformation on the light of specific wave bands, and a projection device comprising the same.

2. Descriptions of the Related Art

Over recent years, lightweight and miniaturized projection devices are preferred in the market due to the gradual advancement of projection device manufacturing technologies. The market demands for new and improved products have promoted continuous improvements on the designs of the projection devices. Accordingly, various miniaturized projection devices with higher efficiency and better imaging quality must be developed by the projection device manufacturers to satisfy the market demands.

In most conventional projection devices, a light emitting diode (LED) of a single color is used to emit light onto the sectors of a color wheel that are coated with phosphor materials of different colors. The light emitting element and the color wheel are disposed in parallel along a single axial direction, and light that is reflected or transformed is focused onto an imaging system for imaging purposes. However, in this structure, the blue light has to be reflected multiple times before it can be coupled with the green light and the red light. Because this leads to a great loss in blue light energy, the imaging quality and luminance of the projection devices are compromised. Furthermore, to improve the imaging quality of projection devices, phosphor materials are often coated in a large area on the color wheel. However, this will reduce the heat dissipation area of the color wheel if the area of the color wheel still remains the same. Therefore, the surface area of the color wheel must be increased to meet the heat dissipation requirements of the projection devices. Moreover, as the light emitted by the LED is scattered light, a plurality of condensing lenses must be used to collect the light to improve the light emission efficiency. Consequently, a relatively large internal space is required in the projection devices to accommodate the plurality of condensing lenses, which is in contradiction to the market demands for lightweight and miniaturized products.

Accordingly, an urgent need exists in the art to provide a projection device that has both an efficient illumination system and a small volume and that can improve the heat dissipation efficiency of the illumination system without causing light loss and changing the volume occupied by the color wheel.

### SUMMARY OF THE INVENTION

An objective of the present invention is to provide an illumination system for use in a projection device. By using a laser light source to project a light onto a color wheel and coating phosphor materials on an edge of the color wheel, the light emission efficiency of the illumination system can be improved, the volume of the projection device can be reduced and the heat dissipation efficiency of the illumination system can be improved.

To achieve the aforesaid objective, the present invention provides an illumination system and a projection device comprising the same. The projection device comprises an imaging system and the illumination system. The illumination system comprises a first light source, a color wheel and a reflecting mirror. The first light source provides a first wave band light along a first axial direction. The color wheel rotates around a second axial direction perpendicular to the first axial direction, and a first wave band transforming area is formed partially around an edge of the color wheel. The reflecting mirror is disposed adjacent to the edge of the color wheel. When being projected to the first wave band transforming area, the first wave band light is transformed into a second wave band light by the first wave band transforming area, and then the second wave band light is reflected by the reflecting mirror.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a projection device according to the first embodiment of the present invention;

FIG. 2 is a perspective enlarged view illustrating some of the elements in the first embodiment of the present invention; and

FIG. 3 is a schematic view of a projection device according to the second embodiment of the present invention.

### DESCRIPTION OF THE PREFERRED EMBODIMENT

In the following descriptions, the present invention will be explained with reference to embodiments thereof. The present invention relates to an illumination system and a projection device comprising the same. The projection device may be an apparatus that has projection and displaying functions, such as a digital light processing (DLP) projection display or a liquid crystal display (LCD) projection display. It shall be appreciated that in the following embodiments and the attached drawings, the description of these embodiments is only for the purpose of illustration rather than limitation. Meanwhile, in the following embodiments and the attached drawings, elements not directly related to the present invention are omitted from depiction; and dimensional relationships among the individual elements in the attached drawings are illustrated only for ease of understanding but not to limit the actual scale.

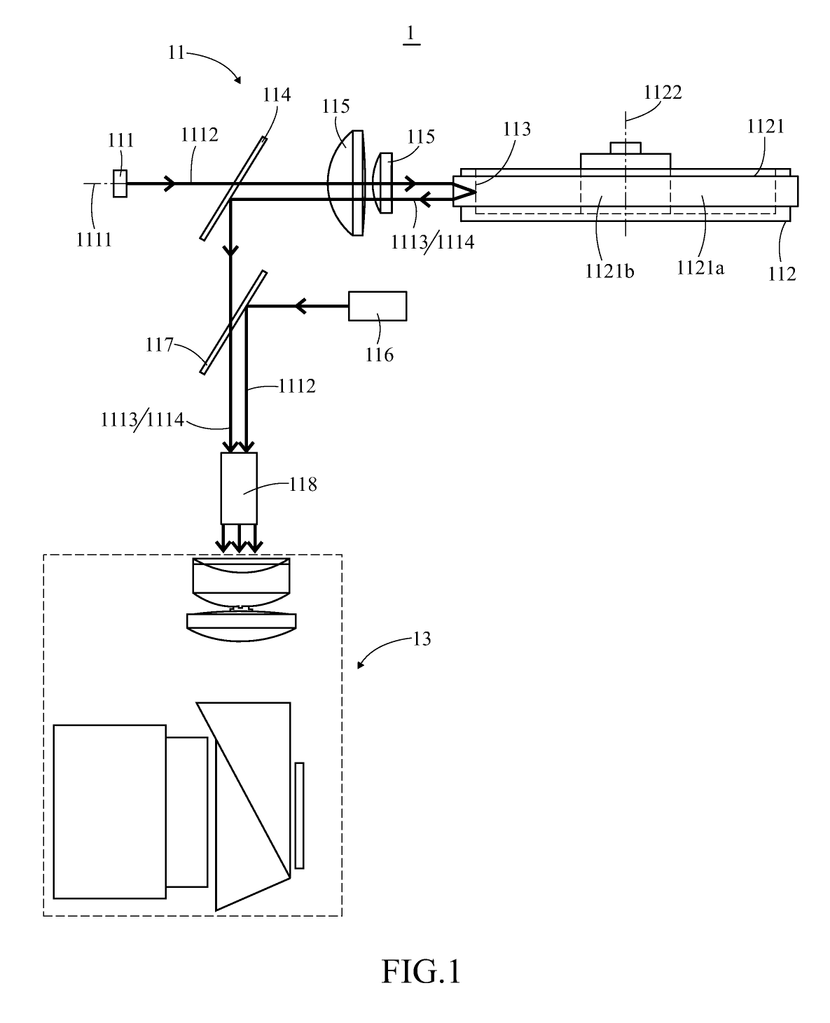

The first embodiment of the present invention is an illumination system 11 for use in a projection device 1. FIG. 1 shows a schematic view of the projection device 1, which comprises an illumination system 11 and an imaging system 13. The illumination system 11 of the projection device 1 is adapted to provide a light (not shown) and output the light to the imaging system 13 so that the imaging system 13 forms an image with the light to display the image (not shown). The illumination system 11 according to the first embodiment of the present invention comprises a first light source 111, a color wheel 112, a reflecting mirror 113, a first dichroic element 114, two condensing elements 115, a second light source 116, a second dichroic element 117 and a light collecting element 118.

In reference to FIG. 1, the first light source 111 of this embodiment comprises a plurality of blue laser light sources (not shown) for providing a plurality of first wave band lights 1112 along a first axial direction 1111, and this can enhance the light intensity of the first wave band lights 1112. In this embodiment, the first wave band lights 1112 are lights within a blue wave band. The first wave band lights 1112 are projected to an edge 1121 of the color wheel 112 in a concentrated way. The edge 1121 refers to a circumferential edge of the color wheel 112. However, it shall be appreciated that the number and the type of the first light source 111 in the present invention is not limited to what is described above, and people skilled in the art may also replace the first light source 111 with other light source structures.

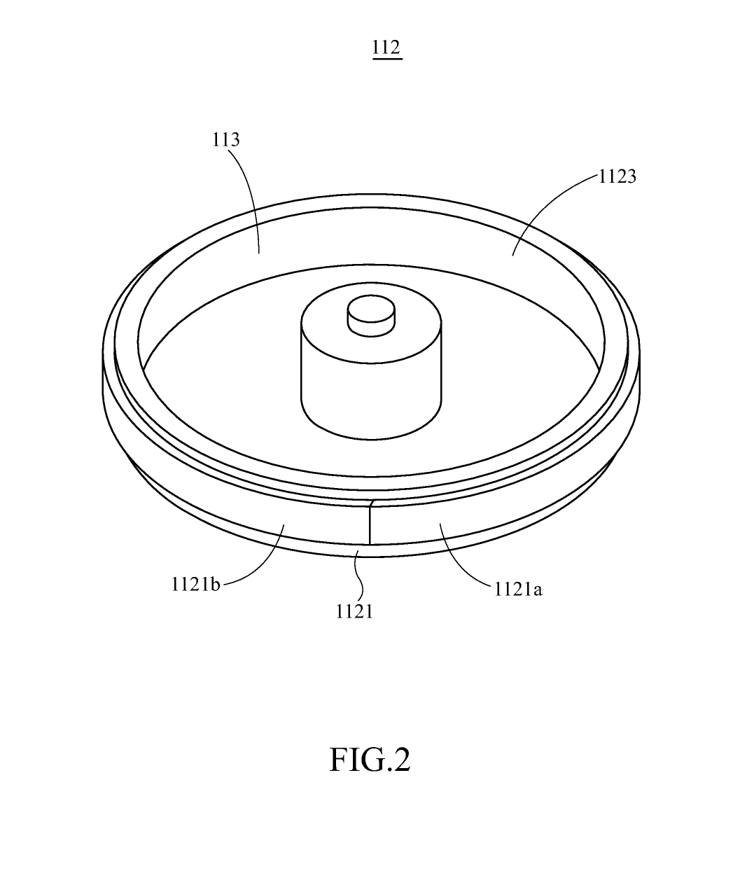

FIG. 2 illustrates a schematic enlarged view of the color wheel 112. The color wheel 112 rotates around a second axial direction 1122 perpendicular to the first axial direction 1111. As shown, a first wave band transforming area 1121a and a second wave band transforming area 1121b are formed around the edge 1121 of the color wheel 112, with the first wave band transforming area 1121a and the second wave band transforming area 1121b adjoining each other and being coated with different phosphor materials. The first wave band transforming area 1121a has a green phosphor material coated on the edge 1121 to transform the first wave band light 1112 into a second wave band light 1113; and the second wave band transforming area 1121b has a red phosphor material coated on the edge 1121 to transform the first wave band light 1112 into a third wave band light 1114. In this embodiment, the second wave band light 1113 is a light within a green wave band, and the third wave band light 1114 is a light within a red wave band. People skilled in the art may appropriately adjust an area ratio of the wave band transforming areas on the color wheel 112 according to the requirements of the light source intensity and the color presentation. Furthermore, a third wave band transforming area may also be additionally provided on the edge 1121, with a yellow phosphor material coated on the third wave band transforming area to transform the first wave band light 1112 into a fourth wave band light (i.e., a light within a yellow wave band). Because the first wave band lights 1112 provided by the blue laser light sources are thin and straight and have concentrated energy, the area necessary for the first wave band transforming area 1121a and the second wave band transforming area 1121b only needs to be larger than a sectional area of the first wave band lights 1112.

Still with reference to FIG. 2, the reflecting mirror 113 is disposed adjacent to the edge 1121 of the color wheel 112. In this embodiment, the reflecting mirror 113 is disposed on a back side 1123 of the first wave band transforming area 1121a and the second wave band transforming area 1121b (i.e., an inner surface of the edge 1121), and rotates with the color wheel 112. In other words, the reflecting mirror 113 of this embodiment has a reflective material coated on the inner surface of the edge 1121. Thereby, the second wave band light 1113 and the third wave band light 1114 that are projected along the first axial direction 1111 and transformed by the wave band transforming areas 1121a, 1121b will be reflected by the reflecting minor 113 on the inner surface of the edge 1121. The reflected second wave band light 1113 and the reflected third wave band light 1114 are both condensed by the condensing elements 115. However, people skilled in the art may also directly use a plurality of reflecting mirrors.

The first dichroic element 114 is disposed between the first light source 111 and the edge 1121 of the color wheel 112 to permit the first wave band light 1112 to pass therethrough and to reflect the second wave band light 1113 and the third wave band light 1114. In this embodiment, the second wave band light 1113 is a light within the green wave band, and the third wave band light 1114 is a light within the red wave band. In other words, when the first wave band light 1112 (the blue light) is projected to the first dichroic element 114, it will travel through the first dichroic element 114 directly to one of the two wave band transforming areas around the edge 1121 of the color wheel 112; and when the second wave band light 1113 (the green light) or the third wave band light 1114 (the red light) is reflected to the first dichroic element 114, it will be reflected by the first dichroic element 114.

The two condensing elements 115 are centered around the first axial direction 1111 and disposed between the first dichroic element 114 and the edge 1121 of the color wheel 112. The two condensing elements 115 are adapted to condense all the light passing therethrough, i.e. the first wave band light 1112 is condensed to the edge 1121 of the color wheel 112 and the second wave band light 1113 and the third wave band light 1114 are condensed to the first dichroic element 114. In this embodiment, each of the condensing elements 115 is a convex lens; however, other embodiments in which a different number of condensing elements 115 or condensing elements 115 in other forms or made of other materials are used may also be readily devised by people skilled in the art.

Similar to the first light source 111, the second light source 116 also has a plurality of blue laser light sources for providing a first wave band light 1112 to the second dichroic element 117. In other embodiments, the second light source may be a single blue laser light source, and may also be at least one blue light emitting diode (LED).

The second dichroic element 117 is disposed between the first dichroic element 114 and the light collecting element 118 to permit the second wave band light 1113 and the third wave band light 1114 to pass therethrough and to reflect the first wave band light 1112. Thereby, the second dichroic element 117 can focus all of the second wave band light 1113 and the third wave band light 1114 passing therethrough and the first wave band light 1112 reflected from the second dichroic element 117 to the light collecting element 118. Furthermore, the light collecting element 118 of the present invention may be a light tunnel or an integration rod. It shall be appreciated that the first wave band light 1112, the second wave band light 1113 and the third wave band light 1114 are projected at different time points according to a particular time sequence, but are not provided to the imaging system 13 at the same time.

Hereinafter, the operating mechanism of the illumination system 11 of this embodiment will be described in detail.

When the illumination system 11 is to provide the green light according to the time sequence, the blue laser light sources of the first light source 111 emit the first wave band light 1112, which passes through the first dichroic element 114 and is then condensed by the condensing elements 115 to the first wave band transforming area 1121a on the color wheel 112. Thus, the first wave band light 1112 is transformed into the second wave band light 1113, which is reflected by the reflecting mirror 113 along the first axial direction 1111. The second wave band light 1113 is condensed by the condensing elements 115 to the first dichroic element 114. Here, the second wave band light 1113 is reflected by the first dichroic element 114 and passes through the second dichroic element 117 to the light collecting element 118 to be uniformized.

However, when the illumination system 11 is to provide the red light according to the time sequence, the blue laser light sources of the first light source 111 emit the first wave band light 1112, which passes through the first dichroic element 114 and is then condensed by the condensing elements 115 to the second wave band transforming area 1121b on the color wheel 112. Thus, the first wave band light 1112 is transformed into the third wave band light 1114, which is reflected by the reflecting mirror 113 along the first axial direction 1111. The third wave band light 1114 is condensed by the condensing elements 115 to the first dichroic element 114. Here, the third wave band light 1114 is reflected by the first dichroic element 114 and passes through the second dichroic element 117 to the light collecting element 118 to be uniformized.

Furthermore, when the illumination system 11 is to provide the blue light according to the time sequence, the blue laser light sources of the second light source 116 emit the first wave band light 1112 to the second dichroic element 117, and the first wave band light 1112 is then reflected by the second dichroic element 117 to the light collecting element 118 to be uniformized. According to the above descriptions, the first wave band light 1112, the second wave band light 1113 and the third wave band light 1114 are all projected to the light collecting element 118 to be uniformized so that the first wave band light 1112 within the blue wave band, the second wave band light 1113 within the green wave band and the third wave band light 1114 within the red wave band are outputted to the imaging system 13. Thereby, the imaging system 13 forms an image with the first wave band light 1112, the second wave band light 1113 and the third wave band light 1114, and then projects and displays the image.

By disposing the color wheel 112 to be centered around the second axial direction 1122 and perpendicular to the first axial direction 1111, the volume necessary for the projection device 1 can be reduced. Furthermore, by coating the green phosphor material and the red phosphor material on the edge 1121 of the color wheel 112, not only is the original area of the color wheel 112 maintained, but also the heat dissipation efficiency of the illumination system 11 can be further improved because of the increased heat dissipation area of the color wheel 112.

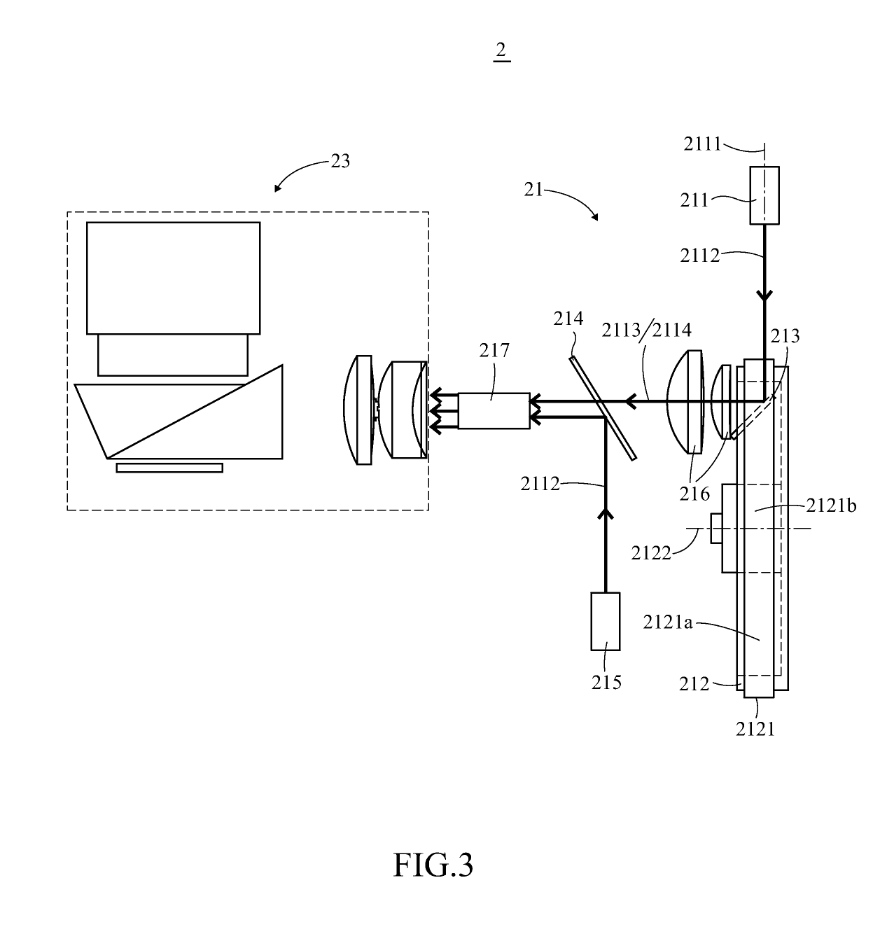

The second embodiment of the present invention is an illumination system 21 for use in a projection device 2. A schematic view of the projection device 2 is shown in FIG. 3. The projection device 2 comprises an illumination system 21 and an imaging system 23. The illumination system 21 of the projection device 2 is adapted to provide a light (not shown) and output the light to the imaging system 23 so that the imaging system 23 forms an image with the light to display the image (not shown). The illumination system 21 according to the second embodiment of the present invention comprises a first light source 211, a color wheel 212, a reflecting mirror 213, a dichroic element 214, a second light source 215, two condensing elements 216 and a light collecting element 217. The elements of this embodiment are similar to those of the first embodiment, and will be detailed as follows.

FIG. 3 illustrates the first light source 211 of this embodiment, which comprises a plurality of blue laser light sources (not shown) for providing a plurality of first wave band lights 2112 along a first axial direction 2111. In this way, the light intensity of the first wave band lights 2112 can be enhanced. The first wave band lights 2112 are lights within a blue wave band. That is, the first light source 211 of this embodiment adopts a design similar to that of the first light source 111 of the previous embodiment. The first wave band lights 2112 are projected to an edge 2121 of the color wheel 212 in a concentrated way, and the edge 2121 refers to a circumferential edge of the color wheel 212.

FIG. 2 also illustrates a schematic enlarged view of the color wheel 112, which is roughly the same as the color wheel 212 of this embodiment. The color wheel 212 rotates around a second axial direction 2122 perpendicular to the first axial direction 2111. A first wave band transforming area 2121a and a second wave band transforming area 2121b are formed around the edge 2121 of the color wheel 212, with the first wave band transforming area 2121a and the second wave band transforming area 2121b adjoining each other and coated with different phosphor materials. The first wave band transforming area has a green phosphor material coated on the edge 2121 to transform the first wave band light 2112 into a second wave band light 2113, while the second wave band transforming area has a red phosphor material coated on the edge 2121 to transform the first wave band light 2112 into a third wave band light 2114. In this embodiment, the second wave band light 2113 is a light within a green wave band, and the third wave band light 2114 is a light within a red wave band. People skilled in the art may appropriately adjust an area ratio of the wave band transforming areas on the color wheel 212 according to the requirements of the light source intensity and the color presentation. Furthermore, a third wave band transforming area, which is coated with a yellow phosphor material, may also be additionally provided on the edge 2121 to transform the first wave band light 2112 into a fourth wave band light (i.e., a light within a yellow wave band).

The most prominent difference of this embodiment from the previous embodiment is that: the reflecting mirror 213 is disposed on the other side of the color wheel 212 that is opposite to the wave band transforming areas, and reflects the second wave band light 2113 and the third wave band light 2114 along the second axial direction 2122; i.e., the second wave band light 2113 and the third wave band light 2114 after being transformed pass through the first wave band transforming area 2121a and the second wave band transforming area 2121b and further travel to the reflecting mirror 213 in the color wheel 212. The reflected second wave band light 2113 and the reflected third wave band light 2114 will be both condensed by the condensing elements 216.

In more detail, the reflecting mirror 113 described in the first embodiment is a reflective material coated on the back side 1123 of the wave band transforming areas and rotates with the color wheel 112. As compared to this, the reflecting mirror 213 in this embodiment is fixed in the illumination system 21 without rotating with the color wheel 212.

The two condensing elements 216 are disposed between the reflecting mirror 213 and the dichroic element 214 in a direction parallel to the second axial direction 2122. The two condensing elements 216 are adapted to condense the second wave band light 2113 and the third wave band light 2114 to the dichroic element 214. In this embodiment, each of the condensing elements 216 is a convex lens; however, other embodiments in which a different number of condensing elements and condensing elements in other forms or made of other materials are used may also be readily devised by people skilled in the art.

Similar to the first light source 211, the second light source 215 also has a plurality of blue laser light sources for providing a first wave band light 2112 to the dichroic element 214. In other embodiments, the second light source may be a single blue laser light source, and may also be at least one blue light emitting diode (LED).

The dichroic element 214 is disposed between the condensing elements 216 and the light collecting element 217 to permit the second wave band light 2113 and the third wave band light 2114 to pass therethrough and to reflect the first wave band light 2112. Then, the dichroic element 214 focuses all of the lights passing therethrough or reflected therefrom to the light collecting element 217. In this embodiment, the second wave band light 2113 is a light within the green wave band, while the third wave band light 2114 is a light within the red wave band. Furthermore, the light collecting element 217 of the present invention may be a light tunnel or an integration rod. Likewise, the first wave band light 2112, the second wave band light 2113 and the third wave band light 2114 are projected at different time points according to a particular time sequence, but are not provided to the imaging system 23 at the same time.

Hereinafter, the operating mechanism of the illumination system 21 of this embodiment will be described in detail.

When the illumination system 21 is to provide the green light according to the time sequence, the blue laser light sources of the first light source 211 emits the first wave band light 2112 to the first wave band transforming area 2121a on the color wheel 212, and then the second wave band light 2113 obtained through transformation passes through the first wave band transforming area 2121a and is reflected by the reflecting mirror 213 along the second axial direction 2122. The second wave band light 2113 is condensed by the condensing elements 216 to the dichroic element 214. Here, the second wave band light 2113 passes through the dichroic element 214 to the light collecting element 217 to be uniformized.

When the illumination system 21 is to provide the red light according to the time sequence, the blue laser light sources of the first light source 211 emits the second wave band light 2113 to the second wave band transforming area 2121b on the color wheel 212, and then the third wave band light 2114 obtained through transformation passes through the second wave band transforming area 2121b and is reflected by the reflecting minor 213 along the second axial direction 2122. The third wave band light 2114 is condensed by the condensing elements 216 to the dichroic element 214. Here, the third wave band light 2114 passes through the dichroic element 214 to the light collecting element 217 to be uniformized.

Furthermore, when the illumination system 21 is to provide the blue light according to the time sequence, the blue laser light sources of the second light source 215 emit the first wave band light 2112 to the dichroic element 214 and the first wave band light 2112 is then reflected by the dichroic element 214 to the light collecting element 217 to be uniformized. According to the above descriptions, the first wave band light 2112, the second wave band light 2113 and the third wave band light 2114 are all projected to the light collecting element 217 to be uniformized so that the first wave band light 2112 within the blue wave band, the second wave band light 2113 within the green wave band and the third wave band light 2114 within the red wave band are outputted to the imaging system 23. Thereby, the imaging system 23 forms an image with the first wave band light 2112, the second wave band light 2113 and the third wave band light 2114, and then projects and displays the image.

By coating the green phosphor material and the red phosphor material on the edge 2121 of the color wheel 212, not only is the original area of the color wheel 212 maintained, but also the heat dissipation efficiency can be further improved because of the increased heat dissipation area of the color wheel 212.

The numbers and positions of the elements in the aforesaid embodiments may be optionally adjusted. For example, in the second embodiment, a plurality of condensing elements 216 may be additionally provided between the first light source 211 and the color wheel 212 to further concentrate the first wave band light 2112 onto the color wheel 212. Furthermore, in the embodiments, the color wheel may also be coated with phosphor materials of other colors (e.g., a yellow phosphor material) to meet needs for different imaging colors so that the colors are made more vivid or attractive or the brightness is increased.

According to the above descriptions, with the use of minimum volume, the illumination system of the present invention uses independent blue laser light sources and wavelength transforming areas coated with a red phosphor material and a green phosphor material instead of using a single light source to project light onto a color wheel. As a result, the heat dissipation efficiency of the illumination system is improved. In this way, the problems with conventional projection devices can be significantly improved using the illumination system of the present invention.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An illumination system, comprising:
a first light source, providing a first wave band light along a first axial direction;
a color wheel, rotating around a second axial direction perpendicular to the first axial direction, a first wave band transforming area being formed partially around an edge of the color wheel; and
a reflecting mirror, disposed adjacent to the edge of the color wheel,
wherein when being projected to the first wave band transforming area, the first wave band light is transformed into a second wave band light by the first wave band transforming area, and then the second wave band light is reflected by the reflecting mirror.

2. The illumination system as claimed in claim 1, wherein the second wave band light is reflected along the first axial direction by the reflecting mirror.

3. The illumination system as claimed in claim 2, further comprising a dichroic element disposed between the first light source and the edge of the color wheel to permit the first wave band light to pass therethrough and to reflect the second wave band light.

4. The illumination system as claimed in claim 2, wherein a second wave band transforming area adjoining the first wave band transforming area is further formed partially around the edge of the color wheel, and when being projected on the second wave band transforming area, the first wave band light is transformed into a third wave band light by the second wave band transforming area, and then the third wave band light is reflected along the first axial direction by the reflecting mirror.

5. The illumination system as claimed in claim 4, further comprising a dichroic element disposed between the first light source and the edge of the color wheel to permit the first wave band light to pass therethrough and to reflect the second wave band light and the third wave band light.

6. The illumination system as claimed in claim 1, wherein the second wave band light is reflected along the second axial direction by the reflecting mirror.

7. The illumination system as claimed in claim 6, wherein a second wave band transforming area adjoining the first wave band transforming area is further formed partially around the edge of the color wheel, and when being projected on the second wave band transforming area, the first wave band light is transformed into a third wave band light by the second wave band transforming area, and then the third wave band light is reflected along the second axial direction by the reflecting mirror.

8. The illumination system as claimed in claim 1, wherein the first light source comprises a plurality of blue laser light sources and the first wave band light is a blue light.

9. The illumination system as claimed in claim 1, further comprising a second light source having at least one blue laser light source or at least one blue light emitting diodes (LEDs).

10. The illumination system as claimed in claim 4, wherein the first wave band transforming area and the second wave band transforming area are coated with a green phosphor material, a red phosphor material or a yellow phosphor material respectively, and the phosphor material coated on the first wave band transforming area is different from that coated on the second wave band transforming area.

11. The illumination system as claimed in claim 7, wherein the first wave band transforming area and the second wave band transforming area are coated with a green phosphor material, a red phosphor material or a yellow phosphor material respectively, and the phosphor material coated on the first wave band transforming area is different from that coated on the second wave band transforming area.

12. A projection device, comprising:
an illumination system as claimed in claim 1, providing a first wave band light, a second wave band light and a third wave band light; and
an imaging system, forming an image with the first wave band light, the second wave band light and the third wave band light provided by the illumination system.

13. The projection device as claimed in claim 12, wherein the illumination system comprises a second light source providing the first wave band light.
